(19) United States
(12) Patent Application Publication
(10) Pub. No.: US 2010/0108407 A1
(43) Pub. Date: May 6, 2010

(54) Stop Motion Scale Conveyor System and Method

(76) Inventor: Timothy P. Van Brunt, Greenwood, AR (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 12/264,607

(22) Filed: Nov. 4, 2008

(51) Int. Cl. G01G 19/00

(52) U.S. Cl. 177/145

(57) ABSTRACT

A system and method are provided which enable rapid static weight measurements of packages within a conveyor system. High through-put rates at, or greater than, in-motion scale systems are achieved at static scale accuracies. The system can be employed in existing conveyor systems to decrease man-hours, increase production, and improve weighing accuracy. The system can accommodate packages which vary in size or in type within a given conveyor run. Fins are affixed to the scale base and positioned to run parallel to and in between conveyor belts. Conveyor belts over the scale base are pivoted to expose the fins upon which the package to be weighed subsequently rests. After weighing, belts are returned to the horizontal position and conveying resumes.

### BACKGROUND OF THE INVENTION

The present invention relates generally to weighing of items on a conveyer system and more particularly to fast and accurate weighing of packages within a conveyer system. Industry competition requires fast packaging, weighing, and labeling of a multitude of items in various containers and packaging. Even individual items not combined into a package per se may require accurate weighing within a conveyor system.

Business members, Governments, and metrology professionals recognize the necessity of accurate weighing within the marketplace. The International Bureau of Weights and Measures (BIPM) defines metrology as, in part, the science of measuring. Metrology is an essential part of societal and environmental welfare. For example, legal metrology ensures fair trade, public safety, and consumer protection. Applied metrology ensures the suitability of measurement instruments, calibration of the same, and quality control of measurements as applied in industry. In addition to existing national and international standards, many manufacturing sectors have industry standards to meet their own industry-specific needs for accuracy and fairness.

The National Type Evaluation Program (NTEP) for National Standards ensures that new commercial weighing and measuring devices which come to market meet applicable standards. An official NTEP Certificate of Conformance is issued by the National Conference on Weights and Measures (NCWM) following successful completion of the evaluation and testing of a device. This Certificate of Conformance indicates that the device meets applicable requirements for commercial weighing and measuring equipment in the United States.

Conventional conveyer systems, which incorporate a package weighing step include an in-motion scale. In such a system, the package never stops moving. Multiple weight measurements are made and averaged for a resultant weight of any one package as it continues to traverse. High through-put rates can be achieved with a conventional in-motion scale conveyor system, yielding a high production rate of 16 to 20 packages weighed and conveyed per minute. The accuracy of conventional in motion scales is not as high as the accuracy achievable with static scales, where the item actually comes to rest.

It would be desirable to maintain high package production and conveying speeds while achieving high accuracy in the weighing of the goods. It would further be desirable if NTEP certification was assured with high through-put rates. It would also be desirable if even higher through-put rates could be achieved. Increased through-put rates via a scale conveying system can, in turn, reduce man-hours, increase production, and increase profits.

### SUMMARY OF THE INVENTION

The present invention addresses some of the issues present in a system of weighing conveying packages. The present invention provides a stop-motion scale for weighing of packages in a conveyor system. Certain aspects of the present invention are briefly described below but are not exhaustive. Further, any one embodiment in accordance with the present invention may include any of the certain aspects described or may not include any of the aspects below.

One aspect of the present invention is that it may be incorporated into a standard conveyor system. Another aspect of the present invention is that the package may come to rest on the load cell for accurate static weighing. Still other aspects include that the system and method may provide a higher through-put rate than conventional in-motion scale conveyor systems and may provide greater accuracy than that achieved with convention in-motion scale systems.

Another aspect of the present invention may be that is configured to accommodate packages of various, size, weight, and type, which may or may not vary in a given run. Further, embodiments of the present invention may meet the NTEP standards for accurate weight measurement. Embodiments of the present invention may provide ready accommodation of various types of packaging and utilization of existing conveyor systems and/or sorters.

Embodiments of the present invention may allow accurate measurement of regardless of the packaging form. Yet another aspect of the present invention may be to enable reduced man-hours for a given volume of items in bulk which are packaged, weighed, and conveyed, and similarly to reduce man-hours for a given number of packages in a weighing and conveying system. Further, embodiments of the present invention may enable higher than conventional throughput rates, while achieving NTEP standards for weight accuracy.

Yet another aspect of the present invention may be to provide automatic accurate sorting for packages within a desired range versus those that do not fall within the desired weight range. Packages weighed and conveyed through embodiments of the present invention system and method may not have to be of a uniform shape, size, or material. Embodiments of the present invention may automatically transition between one satisfactory weight range and another, while also readily accommodating different sized packages. Non-uniform packages within a single run or across multiple runs may be readily accommodated in accordance with one or more exemplary embodiments of the present invention.

Those skilled in the art will further appreciate the above-noted features and advantages of the invention together with other important aspects thereof upon reading the detailed description that follows in conjunction with the drawings.

### BRIEF DESCRIPTION OF THE FIGURES

For more complete understanding of the features and advantages of the present invention, reference is now made to the detailed description of the invention along with the accompanying figures, wherein:

FIG. 1 shows an aspect view of a conveyor system incorporating a stop motion scale conveyor system according to an exemplary embodiment of the present invention;

FIG. 2 shows an end view of the weighing portion of an exemplary embodiment of the present invention;

FIGS. 3a-3b show front views of the weighing portion of a stop motion conveyor system in accordance with the present invention in the weighing and conveying positions, respectively;

FIG. 4 shows the conveyor belt scale section in an upright position for maintenance, in accordance with the present invention; and

FIG. 5 shows a top view of the static weighing section and the reject belts in accordance with an embodiment of the present invention.

### DETAILED DESCRIPTION OF THE INVENTION

The invention, as defined by the claims, may be better understood by reference to the following detailed description. The description is meant to be read with reference to the figures contained herein. This detailed description relates to examples of the claimed subject matter for illustrative purposes, and is in no way meant to limit the scope of the invention. The specific aspects and embodiments discussed herein are merely illustrative of ways to make and use the invention, and do not limit the scope of the invention. Element numbers in the figures are consistent across figures, however, elements are not necessarily identical across figures and element numbers are not drawn to a particular embodiment.

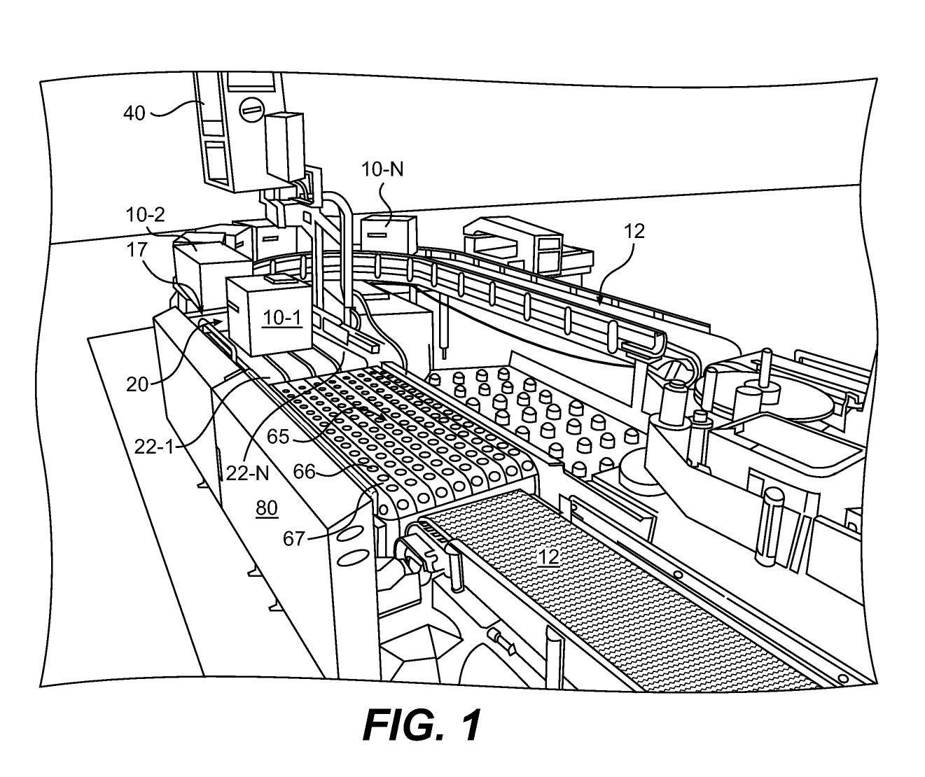

FIG. 1 shows a perspective view of a conveying system incorporating a stop-motion scale conveyor system in accordance with an exemplary embodiment of the present invention. Packages 10 circle around to the static weighing section 20 on a standard racetrack conveying system 12. In alternate embodiments, any one of or a combination of conveying section types are possible. For example, while FIG. 1 shows a racetrack conveyor system 12, a power roller system could also be used. As package 10-1 enters the static weighing station, a pop stop 17 rises to prevent box 10-2 from entering the static weighing station. The belt assembly 22 in the static weighing section pivots downward at one end. The package 10-1 rests on fins 50 which are positioned between belts 22-1, 22-2, . . . 22-n. In the perspective view of FIG. 1, the package 10-1 appears to be floating slightly above the belts 22.

Just down stream of the static weighing station is the rejection conveyor section 65. Here, small spherical rollers 66 reside in a column within each belt 67. When electrically activated these spheres rotate to move the package resting on the spheres perpendicular to the belts to the rejection station 80. Above the static weighing section 20 is the weight display 40 which displays the package weight and can also provide additional user interface information.

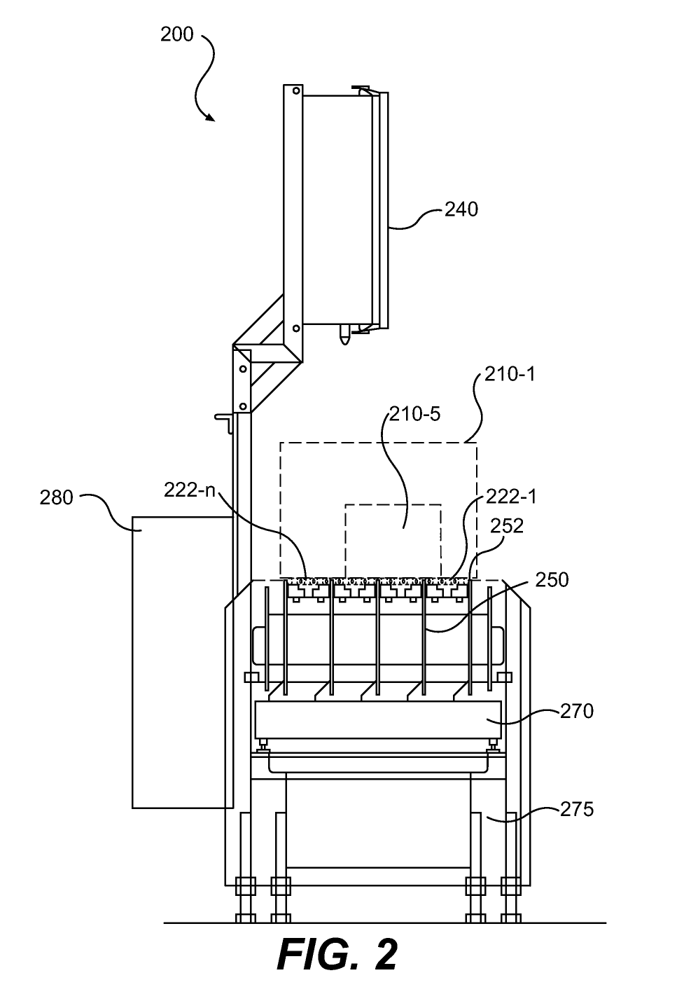

FIG. 2 shows an end view of a stop-motion scale conveyor section 220. Starting from the top, display 240 utilizes an NTEP-approved indicator to display the weights measured using an NTEP-approved scale base 270. By using the combination of an approved scale base and an approved indicator, the resulting weight measurements in accordance with the present invention are within NTEP standards. While in the particular embodiment shown in FIGS. 1 and 2, the scale base type is certified for weights between 10 and 70 lbs, the present invention can be implemented using any desired scale base to accurately measure packages within the certified weight range. Affixed to the scale base 270 are fins 250. The fins are positioned parallel to the belts 222 with a fin 250 between any two belts 222-1 and 222-2 to 222-n and 222-(n−1). In the embodiment of FIG. 2, two additional fins are placed on the outer-side of each outermost belt, 222-1 and 222-n.

While, in the embodiment shown in FIG. 2, the belt 222 width is less than 3⅞ inches to permit a center fin spacing of 3⅞ inches, in other embodiments different belt widths can be used. For example, ribbon belts or multi-strand rubber band type belts could be used. In turn, a fin 250 can still be spaced between each band type belt or between any multiple number of belts depending on the spacing desired to hold the package to be weighed. Thinner belts and denser fin spacing can accommodate a wider range of package sizes. Fins 250, affixed to the scale base 270 and positioned on the outside of the outermost belts, are likewise optional. The fins themselves can be made of a variety of materials constructed to yield sufficient rigidity to support the packages resting thereon. For example, light weight aluminum, high strength stainless steel, carbon-steel in a non-wash-down environment, or plastic in a corrosive environment can all be used as fin material. The fins must be securely affixed to the scale base, essentially raising the scale base up to the belt surface. The fins can be affixed by welding or alternately secured to the scale base 270, effectively raising the surface of the scale base 270. As shown in FIG. 2, the top edge 252 of each fin 250 is just below the belt surface 222, such that a package 210-1 rests on the belts and not the fins when the belts are in a conveying position. In FIG. 1, the package 10-1 is resting on the fins as the belts 22 have been lowered. In still another embodiment, only a single belt 222′ of a width perhaps equal to the sum of several belts 222, shown in FIG. 2, is used to convey packages across the scale base, while at least one fin 250 is affixed on each outer side of belt 222′.

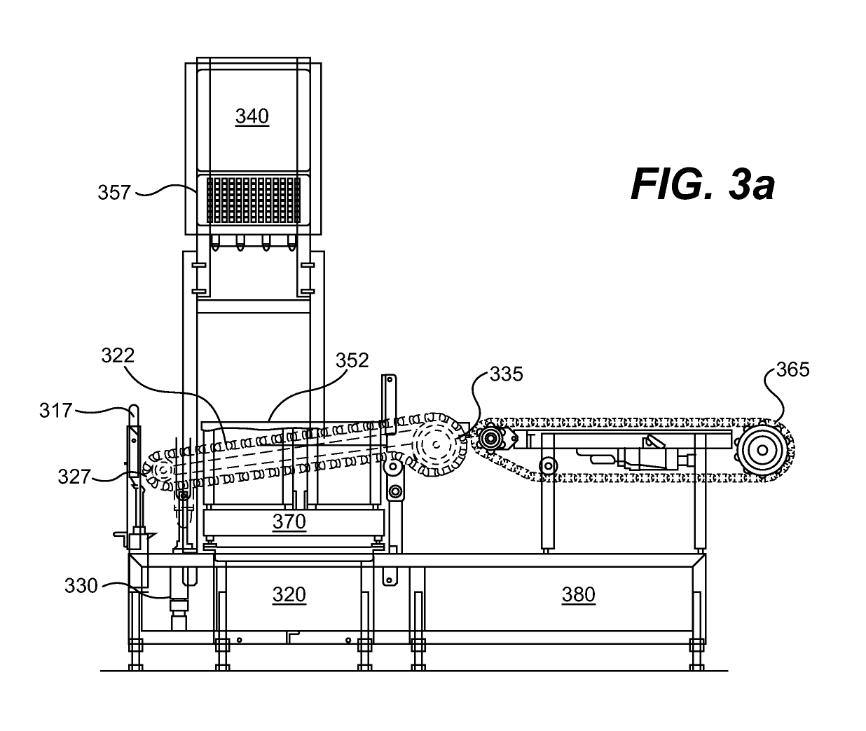

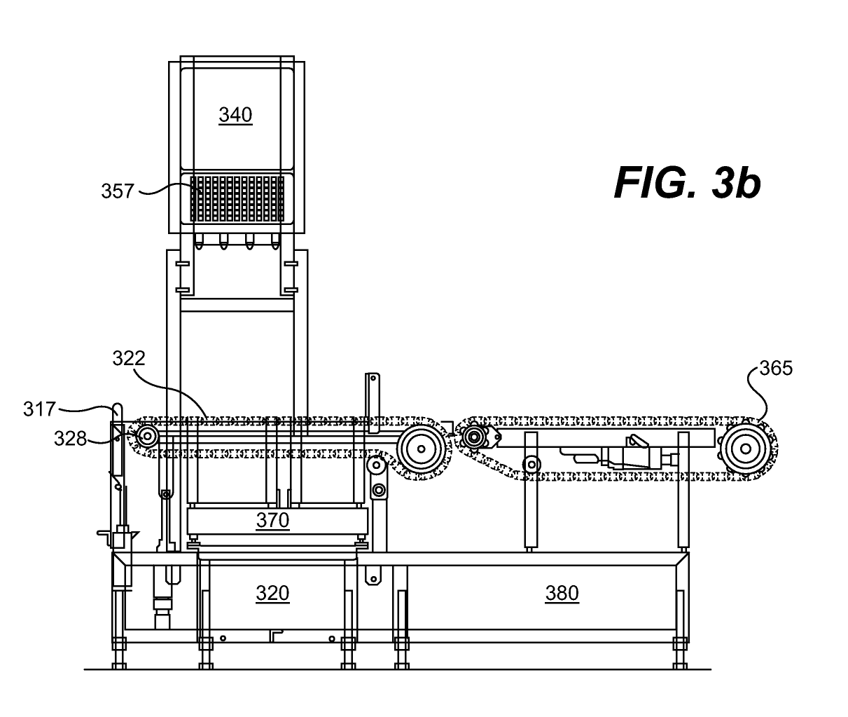

FIG. 3a shows a front view of the weighing section 320 and the rejection section 380 of an embodiment according to the present invention. In the embodiments shown in FIG. 3a, the weighing section belts 322 extend left and right past the fins, 350. Pivot point 335 of the belt system extends beyond the length of the fins to the right. In the embodiment shown in FIG. 3a, the belts 322 are clearly shown extending past the edges of the scale base 370 on both sides. The belts 322, shown for example as 222-1 to 222-n in FIG. 2, are pivoted down to position 327 about pivot point 335 exposing the tops of the fins, where the top of one fin 352 is shown. In alternate embodiments, the belts may not extend past the scale, however, tilting of the belts exposes fins. A package on the belts 322 lays down across the fins upon lowering of the belts. In the embodiment shown in FIG. 3a, an air cylinder 330 with a self-aligning free-floating connection to the left end of the frame supporting the weigh section belts is used to lower the left side of the belt bed 322. While self-aligning free-floating attachments provide accurate repeatable performance, in other embodiments, equivalent lowering mechanisms and attachments can be used. For example, a hydraulic cylinder can be used in place of an air cylinder. The attachment from the lowering apparatus to the belt section 322 can be via pivotal connection to the cylinder rod to a slot connection on the belt frame, where either connection could produce the same up and down translation of the weighing section 320 belt 322 surface. Any suitable servo-linear actuator can be used with a free-floating connection to lower an end of the belt bed 322. In the embodiment shown in FIG. 3a, a 3 inch deflection on the left side of the weighing belt bed is used.

FIG. 3a also shows a front view of the pop stop 317, which raises upon the crossing of a package. This restricts the number of packages on the weighing conveyor section to one before the weighing conveyor bed section is lowered. FIG. 1 also shows a raised pop stop 17. A device which governs the flow of packages or product entering the weighing belt section need not be a pop stop. In alternate embodiments, an alternate apparatus may be used to control product or package entry onto the weighing section belts.

FIG. 3b shows the weighing belt section 322 returned to its original horizontal position with the left side raised 328. Once again the package rests on the belt bed 322 and the fins are below the belt bed surface. Note the relationship between the top of the fins and the weighing section belts is shown in FIG. 2. The pop stop 317 as shown in FIG. 3b is still raised preventing upstream packages from entering the weight section. As the belts 322 in the weighing section are powered to convey, the pop stop 317 lowers to allow an upstream package to enter the weighing section as the weighed package leaves the weighing section and enters the reject belt section 365.

Weights that are outside a range set by the user will result in the package being rejected when it leaves the weighing section. FIG. 3b shows rejection section 380, wherein the rejection section belts 365 comprise spheres, not shown, which are free spinning until activated to rotate perpendicular to the belts. An exemplary embodiment of a rejection section comprising sphere 66 is shown in FIG. 1. Note that alternate mechanisms can be activated in accordance with the present invention to sort packages which weigh outside of a desired range.

Various means of indicating a measured package weight outside of the desired weight range can be provided, in accordance with the present invention. For example, the measured weight may be shown on the display 340 for a user's viewing, which may or may not include an indication of pass status. Pass and fail indicator lights may or may not be used.

The present invention provides advantages over in motion scale measurements. As the belt bed 322 is lowered, the package comes to rest motionless on the fins and a static weight measurement is taken. In contrast to conveying weighing systems where a package weight measurement is made in motion, multiple measurements are taken and averaged to obtain the resultant weight. In an in-motion system, multiple measurements must be made and the additional averaging calculation must be made. Weights measured with an in-motion scale are conventionally not as accurate as stop-motion or static weighing scales since the package never stabilizes on the load scale. Conventional in-motion weighing conveying systems can yield through-put rates in range of 16 to 20 packages per minute. In contrast, static weight measurements made on the stop motion scale conveyor system in accordance with the present invention can yield package through-put rates of 26 packages per minute. In alternate embodiments, the through-put rates achievable in accordance with the present invention may vary from the 26 packages per minute achieved in one exemplary embodiment. The through-put rate may be dependent, in part, on the dimensions of the package or product to be weighed and conveyed.

In addition, measurements made with a static load base are more accurate than the conventional in-motion scales. Accuracies achievable with static load scales and employed in accordance with the present invention can be plus or minus 0.02 lbs in a weight load range of 40 to 70 lbs. A conventional in-motion scale of a comparable range attains accuracies of plus or minus 0.05 to 0.10 lbs. Depending upon what is being packaged and weighed for subsequent sale and depending on total daily output, the two to five fold increase in accuracy can yield considerable increased profits. In accordance with one exemplary embodiment of the present invention, through-put rates of 28 packages per minute with a static scale accuracy of plus or minus 0.02 lbs. in a 40 to 70 lb. load range can be attained.

The present invention can accommodate multiple sized packages. As long as the package can be steadily supported by two or more of the stationary fins, an accurate weight measurement can be made. Different acceptable weight ranges can be programmed in or set by the user, for example via keyboard 357. Different ways of setting the acceptable weight range during runtime for varying package types can be used in accordance with embodiments of the present invention. Packaging may have, for example, a bar code disposed on the outside which is read by a scanner for setting of the acceptable weight range of that package. Reading of bar codes, and in turn setting of the desired weight range, can be made just before the weighing section or even at the weighing section itself. FIG. 2 shows a profile outline of a subsequent package 210-5, which is much smaller than a previous package 210-1. Package 210-5 may be conveyed and weighed in the same run as package 210-1 or may be part of a subsequent run of packages of size near that of package 210-5. As can be seen in FIG. 2, the present invention can readily accommodate package sizes of both 210-1 and 210-5 as either package will rest stably on fins 250.

Yet another aspect of the present invention is to provide a weighing system which could be used to transport packages to a desired location within a conveyor system, while providing accurate weighing for postage purposes or for verification of postage amount, for example.

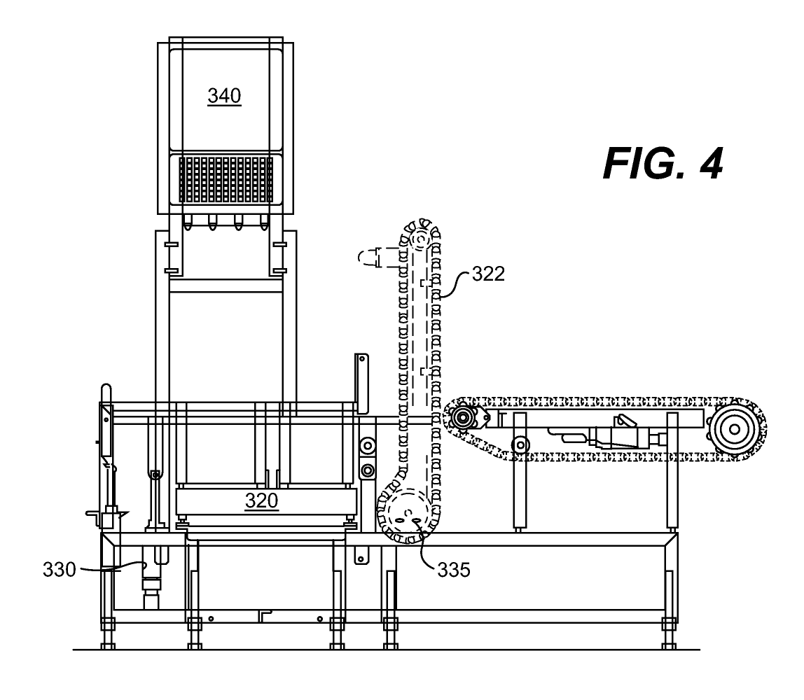

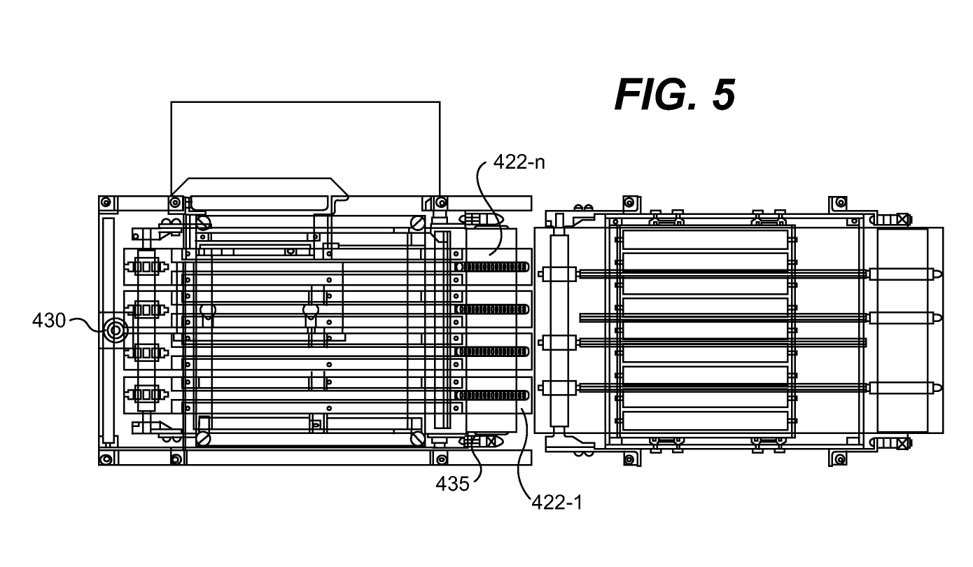

FIG. 4 shows an exemplary embodiment of the present invention with the weighing section belts 322 in an upright position, for maintenance of, for example, the scale, the fins, the belt drive. FIG. 5 shows a top view of the static weighing section and the reject belts in accordance with an embodiment of the present invention. While a single linear actuator 430 is shown, alternate embodiments may comprise additional actuators.

The present invention is readily employed to measure weights of unitary units in a conveyor system. Perhaps an assembly line manufactures, for example, diving bricks which are further packaged but perhaps labeled for later sale. The present invention can readily accommodate any good moving on the conveyor system, as long as the good can come to rest on the fins. Note that the fins must be of sufficient rigidity to provide a stable platform for the object being weighed, and of sufficient strength to withstand the weight of the object.

While specific alternatives to steps of the invention have been described herein, additional alternatives not specifically disclosed but known in the art are intended to fall within the scope of the invention. Thus, it is understood that other applications of the present invention will be apparent to those skilled in the art upon reading the described embodiment and after consideration of the appended claims and drawings.

What is claimed is:

1. A weighing and conveying system, the system comprising:
a weight indicator;
a stop-motion scale base;
at least two fins affixed to the stop-motion scale base;
a conveyor belt weighing section extending across the scale base and comprising:
a set of conveyor belts; a pivot point on a first end of the conveyor belt weighing section; and an actuator on a second end of the conveyor belt weighing section; and
wherein a top of each at least two fins is below a top surface of the set of conveyor belts.

2. The weighing and conveying system according to claim 1, wherein:
the stop motion scale base and the weight indicator each have an official NTEP certificate of conformance.

3. The weighing and conveying system according to claim 1, wherein:
a fin of the at least two fins is positioned in between each conveying belt or between a multiple of the conveying belts.

4. The weighing and conveying system according to claim 3, wherein:
a fin of the at least two fins is positioned on an outside edge of at least one outermost conveying belt.

5. The weighing and conveying system according to claim 1, wherein:
the conveyor belt weighing section comprises one or more conveying belts which run between the at least two fins in absence of fins in between any two belts.

6. The weighing and conveying system according to claim 1, wherein:
the actuator is a pneumatic servo-linear actuator.

7. The weighing and conveying system according to claim 1, further comprising:
a free-floating self-aligning connection between the actuator and the conveyor belt weighing section.

8. The weighing and conveying system according to claim 1, further comprising:
a pop stop which raises to limit upstream packages from entering the conveyor belt weighing section.

9. The weighing and conveying system according to claim 1, further comprising:
a rejection section downstream of the conveyor belt weighing section.

10. The weighing and conveying system according to claim 1, further comprising:
an acceptable weight range selector which varies an acceptable weight range on a package type dependent basis.

11. A method of weighing packaged goods in a conveyor system, the method comprising:
conveying a package to a weighing conveyor belt section;
lowering one end of the weighing conveyor belt section about an opposite pivot point of the weighing conveyor section;
exposing a set of fins just below a resting surface of belts in the conveyor belt weighing section;
resting the package on the fins;
weighing the package resting on the fins, which are affixed to a static scaled base;

12. The method according to claim 11, further comprising:
raising a pop stop to prevent an upstream package from entering the weighing conveyor belt section.

13. The method according to claim 12, further comprising:
raising the one end of the weighing conveyor belt section about the opposite pivot point to a horizontal position after weighing the package, wherein the package rests upon the surface of belts comprised in the weighing conveyor belt section.

14. The method according to claim 13, further comprising:
lowering the pop stop upon raising the one end of the weighing conveyor belt section; and
powering a drive for the belts comprised in the weighing conveyor belt section.

15. The method according to claim 11, further comprising:
reading an acceptable weight range indicator and setting the acceptable weight range.

16. The method according to claim 15, further comprising:
comparing the weighed amount to the acceptable weight range and either accepting or rejecting the corresponding package based on the comparison.

17. The method according to claim 11, further comprising:
displaying a weight of the weighed package.

18. The method according to claim 14, wherein:
packages are weighed and conveyed at a through-put rate of at least 21 packages per minute.
displaying a weight of the weighed package.

19. The method according to claim 11, further comprising:
labeling packages with respective measure weights.

20. The method according to claim 18, further comprising:
using an NTEP certified scale base and an NTEP certified display.

21. The method according to claim 14, wherein:
packages are weighed to an accuracy of 0.02 lbs.
